(19) United States
(12) Patent Application Publication
(10) Pub. No.: US 2021/0012261 A1
(43) Pub. Date: Jan. 14, 2021

(54) SELF-DRIVING CONTROL DEVICE, VEHICLE, AND DEMAND MEDIATION SYSTEM

(71) Applicant: PANASONIC INTELLECTUAL PROPERTY MANAGEMENT CO., LTD., Osaka (JP)

(72) Inventors: Nobuhiro FUKUDA, Kanagawa (JP); Norihiko KOBAYASHI, Tokyo (JP); Keiji NISHIHARA, Kanagawa (JP); Matthew John LAWRENSON, Lausanne (CH); Julian Charles NOLAN, Lausanne (CH)

(73) Assignee: PANASONIC INTELLECTUAL PROPERTY MANAGEMENT CO., LTD., Osaka (JP)

(21) Appl. No.: 17/032,817

(22) Filed: Sep. 25, 2020

Related U.S. Application Data
(63) Continuation of application No. PCT/JP2019/013485, filed on Mar. 27, 2019.

(30) Foreign Application Priority Data
Mar. 27, 2018 (JP) 2018-060028

(51) Int. Cl. G06Q 10/06; G01C 21/36; B60W 60/00; G05D 1/02

(52) U.S. Cl. CPC G06Q 10/06315; G01C 21/3617; G05D 1/0223; B60W 60/00253; G05D 1/0217; G01C 21/3691

(57) ABSTRACT

A self-driving control device mountable on a vehicle configured to communicate with a server device. The self-driving control device includes: a processor; and a memory including instructions that, when executed by the processor, cause the processor to perform operations including: generating a route to a destination; controlling traveling during self-driving of the vehicle to the destination based on information of the route to the destination; and receiving information of a guidance route to a place satisfying the demand transmitted from the server device in response to input operation of a demand on an order of a user. In generating the route to the destination, the processor generates information of a route obtained by merging the guidance route with the route to the destination as the information of the route to the destination in response to approval operation of the user with respect to the place.

### CROSS-REFERENCE TO RELATED APPLICATIONS

This application is a continuation of PCT International Patent Application No. PCT/JP2019/013485 filed on Mar. 27, 2019, which claims the benefit of priority of Japanese Patent Application No. 2018-060028 filed on Mar. 27, 2018, the enter contents of which are incorporated herein by reference.

### FIELD

The present disclosure relates to a self-driving control device, a vehicle, and a demand mediation system.

### BACKGROUND

US-A1-2016/0232625 discloses a technique of improving convenience of a user by performing a more appropriate recommendation such as time or a place at the time of event planning when additional information obtained by a sensor or the like is used in addition to information on various preferences of the user in event planning using social networking. An example of the recommendation includes information at a place of an event site where a self-driving vehicle takes along the user for, for example, an appointment.

### SUMMARY

In a society where a self-driving vehicle is expected to be generalized in the future, it is expected that needs to effectively utilize time spent by an occupant in the self-driving vehicle are increased. As an example of effective time utilization in the self-driving vehicle, an event related to a meal of the occupant is considered.

For example, the occupant may want to use a store (for example, a drive-through) during self-driving toward the destination by the self-driving vehicle. In this case, the self-driving vehicle needs to once change a place to go from the destination to a place of the store and to change a route from the place of the store to the destination. However, in US-A1-2016/0232625 described above, it is not considered that the route is changed such that the place to go is changed to the place of the store and further the destination can be reached in order that the occupant can use the drive-through or the like during self-driving with the self-driving vehicle. Further, it is not considered to effectively utilize time that the occupant spends in the self-driving vehicle during self-driving.

The present disclosure is devised in view of the above-described circumstances in the related art, and an object thereof is to provide a self-driving control device, a vehicle, and a demand mediation system that adaptively change a route to a destination depending on simple operation of a user by including a store of a drive-through and make a user effectively use time during self-driving to improve convenience accurately when a user such as a driver wants to use the drive-through during self-driving.

According to the present disclosure, a self-driving control device mountable on a vehicle configured to communicate with a server device, the self-driving control device including: a processor; and a memory including instructions that, when executed by the processor, cause the processor to perform operations including: generating a route to a destination; controlling traveling during self-driving of the vehicle to the destination based on information of the route to the destination; and receiving information of a guidance route to a place satisfying the demand transmitted from the server device in response to input operation of a demand on an order of a user, wherein in generating the route to the destination, the processor generates information of a route obtained by merging the guidance route with the route to the destination as the information of the route to the destination in response to approval operation of the user with respect to the place.

According to the present disclosure, there is provided a vehicle configured to communicate with a server device and including a self-driving control device configured to control self-driving, wherein the self-driving control device includes: a processor; and a memory including instructions that, when executed by the processor, cause the processor to perform operations including: generating a route to a destination; controlling traveling during self-driving of the vehicle to the destination based on information of the route to the destination; and receiving information of a guidance route to a place satisfying the demand transmitted from the server device in response to input operation of a demand on an order of a user, wherein in generating the route to the destination, the processor generates information of a route obtained by merging the guidance route with the route to the destination as the information of the route to the destination in response to approval operation of the user with respect to the place.

According to the present disclosure, there is provided a demand mediation system including: a vehicle including a self-driving control device configured to control self-driving; and a server device, wherein the vehicle and the server are configured to communicate with each other, wherein the vehicle inncludes: a first processor; and a first memory including instructions that, when executed by the first processor, cause the first processor to perform first operations including: transmitting demand information including information of a destination and position information of the vehicle to the server device in response to input operation of a demand on an order of the user during self-driving to the destination, wherein the server device includes: a second processor; and a second memory including instructions that, when executed by the second processor, cause the second processor to perform second operations including: searching at least one place satisfying the demand; and transmitting information of a guidance route from a position of the vehicle to the at least one place and information on the at least one place to the vehicle based on the demand information transmitted from the vehicle, and wherein the first operation further includes: receiving information of the guidance route transmitted from the server device and information on the at least one place; and generating information of a route obtained by merging the guidance route with a route to the destination as information of the route to the destination in response to approval operation of the user on the at least one place.

Optional combinations of the above constituent elements and presentation of the present disclosure converted between methods, devices, systems, recording media, computer programs, and the like are effective as aspects of the present disclosure.

According to the present disclosure, it is possible to adaptively change the route to the destination in response to simple operation of the user by including a store of a drive-through, and to effectively use time during self-driving by the user to accurately improve convenience.

### BRIEF DESCRIPTION OF DRAWINGS

FIG. 1 is a block diagram showing a configuration example of a demand mediation system using a vehicle including a self-driving control device according to a first embodiment as a center.

FIG. 2 is a flowchart showing an example of a control procedure of self-driving of the vehicle in the self-driving control device according to the first embodiment.

FIG. 3 is a flowchart showing an example of a control procedure of self-driving of the vehicle in the self-driving control device according to the first embodiment.

FIG. 4 is a flowchart showing an example of an operation procedure of guidance route merging processing in the vehicle according to the first embodiment.

FIG. 5 is an explanatory diagram showing a transition example of a general route during self-driving of the vehicle according to the first embodiment.

FIG. 6 is a block diagram showing a configuration example of a demand mediation system using a demand mediation server according to the first embodiment as a center.

FIG. 7 shows a configuration example of user data registered in a user database.

FIG. 8 shows a configuration example of store data registered in a store database.

FIG. 9 is a sequence diagram showing an example of an operation procedure of demand mediation in the demand mediation system according to the first embodiment.

### DETAILED DESCRIPTION

(Circumstances Leading to Content of First Embodiment)

In a society where a self-driving vehicle is expected to be generalized in the future, it is expected that needs to effectively utilize time spent by an occupant in the self-driving vehicle are increased. As an example of effective time utilization in the self-driving vehicle, an event related to a meal of the occupant is considered.

For example, the occupant may want to use a store (for example, a drive-through) during self-driving toward the destination by the self-driving vehicle. In this case, the self-driving vehicle needs to once change a place to go from the destination to a location of the store and to change a route from the location of the store to the destination. At this time, in order to change the route, the self-driving vehicle needs to stop. That is, the route cannot be dynamically changed during traveling of the self-driving vehicle. However, in US-A1-2016/0232625 described above, it is not considered that the route is changed such that the place to go is changed to the location of the store and further the destination can be reached in order that the occupant can use the drive-through or the like during self-driving with the self-driving vehicle. Further, it is not considered to effectively utilize time that the occupant spends in the self-driving vehicle during self-driving.

Further, for effective time utilization in the self-driving vehicle using the occupant (for example, a user such as a driver), it is also expected that highly systematic cooperation between a terminal on a store side capable of providing, for example, a drive-through and the self-driving vehicle is performed as an event related to a meal. That is, it is considered that convenience of the user can be improved by performing various adjustments while going between the terminal on the store side and the self-driving vehicle by a server or the like. Here, items to be adjusted include, for example, selection of a drop-by store (for example, fast food that can be provided at a drive-through), an order of a menu, reservation of a store, change of the route to the destination, and waiting time (for example, receipt waiting time if it is a drive-through). By realizing such adjustment seamlessly, a user (that is, an occupant) of service such as a store can meaningfully use boarding time free from stress, and a provider of service such as a store can expect efficient store management and improvement in a ratio of attracting customers.

Therefore, the following first embodiment describes an example of a self-driving control device, a vehicle, and a demand mediation system that adaptively change a route to a destination in response to simple operation of a user by including a store of a drive-through and make a user effectively use time during self-driving to improve convenience accurately when a user such as a driver wants to use the drive-through during self-driving.

Hereinafter, embodiments that specifically disclose the self-driving control device, the vehicle, and the demand mediation system according to the present disclosure will be described in detail with reference to the accompanying drawings appropriately. However, unnecessarily detailed descriptions may be omitted. For example, detailed description of an already well-known matter or repeated description of substantially the same configuration may be omitted. This is to avoid unnecessary redundancy in the following description and to facilitate understanding of those skilled in the art. The accompanying drawings and the following description are provided for thoroughly understanding the present disclosure by those skilled in the art, and thus are not intended to limit the subject matter described in the claims.

### First Embodiment

In the first embodiment, while a vehicle including a self-driving control device according to the present disclosure (hereinafter, sometimes referred to as “own vehicle”) performs self-driving toward a destination, a user inputs a demand (request) on the order of a menu to a store (for example, a drive-through), and when proposal of the store satisfying the demand is received from a demand mediation server for approval operation, a guidance route to the store is merged with a route to the destination. The vehicle sets the route after merging of the guidance route as a new route and performs self-driving in accordance with the route. The user is, for example, a driver or a fellow passenger of the vehicle, and is the same hereinafter. The guidance route is a route generated by the demand mediation server, specifically a route for guiding the own vehicle from a position of the own vehicle to the store satisfying the demand of the user.

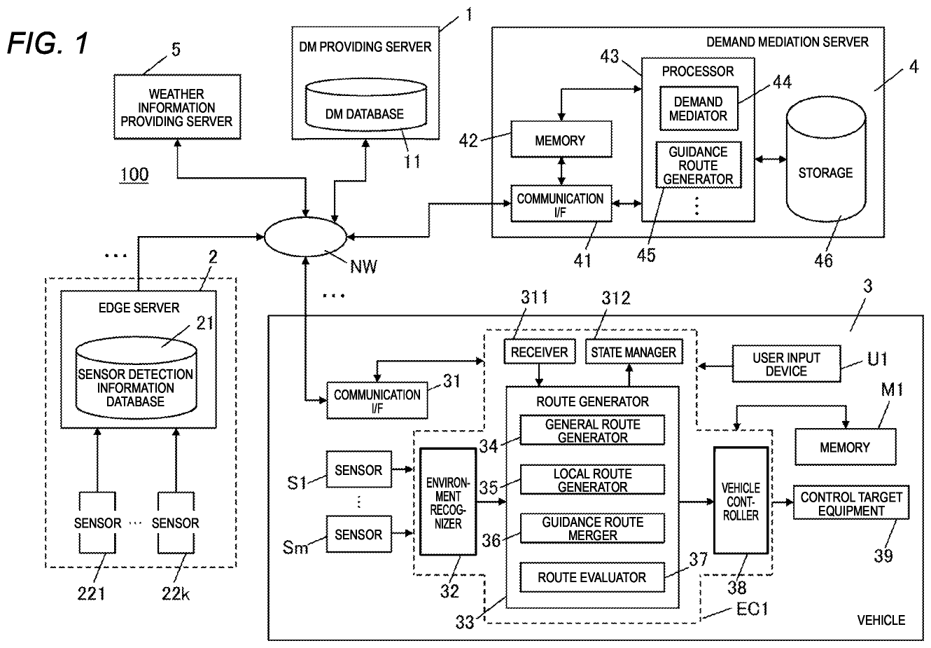

FIG. 1 is a block diagram showing a configuration example of a demand mediation system 100 using a vehicle 3 including a self-driving control device EC1 according to a first embodiment as a center. The demand mediation system 100 includes a dynamic map (DM) providing server 1, an edge server 2, a vehicle 3, a demand mediation server 4, and a weather information providing server 5. The dynamic map (DM) providing server 1, the edge server 2, the vehicle 3, the demand mediation server 4, and the weather information providing server 5 are connected to communicate with each other via a network NW. The network NW is a wireless communication network such as an Internet network or a wireless local area network (LAN).

The DM providing server 1 includes a DM database 11 (for example, a hard disk drive (HDD)) that keeps a dynamic map, which is dynamic road environment information necessary to realize self-driving of the vehicle 3. The DM providing server 1 periodically and repeatedly updates the dynamic map stored in the DM database 11. In response to a periodic request from the vehicle 3 or the demand mediation server 4, the DM providing server 1 acquires data of the dynamic map from the DM database 11 and transmits the data to the vehicle 3 or the demand mediation server 4.

Here, the dynamic map is, for example, digital map data obtained by combining information of positions where dynamic changes such as road congestion information and traffic regulations due to an accident or road construction have occurred with a static highly accurate three-dimensional map data. By using the dynamic map provided from the DM providing server 1, the vehicle 3 can perform self-driving while accurately estimating surrounding environment information based on detection output of a sensor (such as a millimeter-wave radar, an ultrasonic sensor, or an optical camera) mounted on the own vehicle.

The edge server 2 is disposed appropriately (for example, in a plural number) to determine a condition of a real-time road environment on which the vehicle 3 travels (for example, detection and collection of the dynamic changes such as the above congestion, accident, and road construction). For example, k (k: an integer of 2 or more) sensors 221 to 22k are connected to one edge server 2, and the edge server 2 includes a sensor detection information database 21 that keeps information (sensor detection information) detected by the respective sensors 221 to 22k. Each of the sensors 221 to 22k is disposed on, a telegraph pole of a road, a pole of a highway, a guardrail, or the like to detect the condition of the real-time road environment.

Based on sensor detection information detected by the respective sensors 221 to 22k, the edge server 2 determines that road congestion, an accident, road construction, or the like has occurred, and transmits road information including information at the occurrence position to the DM providing server 1 or the vehicle 3. The road information is used, for example, when the dynamic map is updated in the DM providing server 1.

The vehicle 3 includes a user input device U1, sensors S1 to Sm (m: an integer of 2 or more), a memory M1, a communication interface 31, an environment recognizer 32, a route generator 33, a vehicle controller 38, and control target equipment 39. The vehicle 3 is a vehicle having the driving automation level of 1 or more, and a vehicle having the driving automation level of 3 is assumed in the following description. The user input device U1, the sensors S1 to Sm (m: an integer of 2 or more), the memory M1, the communication interface 31, the environment recognizer 32, the route generator 33, the vehicle controller 38, and the control target equipment 39 are connected to each other via an in-vehicle network such as a controller area network (CAN) to allow input and output of data or information.

The vehicle 3 is equipped with the self-driving control device EC1 as an example of a controller for controlling self-driving. Here, as an element for realizing self-driving having the driving automation level 1 or more in a vehicle, it is said that three elements of acknowledgement, determination, and operation are required in the vehicle. Thus, the self-driving control device EC1 according to the first embodiment has a configuration capable of executing processing corresponding to the above three elements, and specifically includes the environment recognizer 32 corresponding to an element of recognition, the route generator 33 corresponding to an element of determination, and the vehicle controller 38 corresponding to an element of operation.

The self-driving control device EC1 includes, for example, an electronic controller (ECU). The self-driving control device EC1 may include a single ECU, or the environment recognizer 32, the route generator 33, and the vehicle controller 38 may separately include different ECUs. One of the environment recognizer 32, the route generator 33, and the vehicle controller 38 may include one ECU, and the remaining two may include different ECUs.

The self-driving control device EC1 operates in accordance with a program and data stored in the memory M1. Specifically, based on output of the environment recognizer 32, the self-driving control device EC1 generates a route of self-driving in the route generator 33. The self-driving control device EC1 performs self-driving while controlling the control target equipment 39 in the vehicle controller 38 in accordance with the route generated by the route generator 33. Self-driving of the vehicle 3 has a function of actuating a brake to stop the vehicle 3 just before the vehicle 3 is about to collide with an obstacle (facilities or the like such as another vehicle, a two-wheel vehicle such as a bike, a pedestrian, a guardrail, a telegraph pole, a pole, and a store. The following is the same). The self-driving of the vehicle 3 includes a function of following while keeping a constant interval with another vehicle running ahead of the vehicle 3. The self-driving of the vehicle 3 includes a function of controlling steering of the vehicle 3 so as not to jut out from a lane, but each function described above is an example of the self-driving, which is not limited to these functions.

The user input device U1 is a device capable of inputting various kinds of data or information by a user (for example, a driver or a fellow passenger of the vehicle 3), and receives operation of a user on a destination setting screen (not shown) displayed on, for example, a human machine interface (HMI, not shown) mounted in the vehicle 3. The user input device U1 outputs information (for example, information of a destination) input by instructions of the user to the self-driving control device EC1.

As will be described in detail later, in addition to the destination setting screen, the HMI displays a selection screen (not shown) of a store (that is, a store capable of providing, for example, a drive-through in a store where the vehicle 3 can drop by during self-self-driving) proposed by the demand mediation server 4 based on the operation of the user. In this case, the user input device U1 inputs operation of the user (for example, approval operation for approving the proposed store) on the selection screen of the store.

The sensors S1 to Sm are provided in the vehicle 3 to detect a surrounding environment of the vehicle 3 and output information detected by each of the sensors S1 to Sm (hereinafter, abbreviated as “detection output”) to the environment recognizer 32. The sensors S1 to Sm include a general positioning system (GPS) receiver, an in-vehicle camera, an around view camera, a radar, and a laser range finder.

The GPS receiver as an example of the sensor receives a plurality of signals indicating time transmitted from a plurality of GPS satellites and a position (coordinate) of each GPS satellite, and calculates a position of the GPS receiver (that is, a position of the vehicle 3) based on the plurality of received signals. The GPS receiver outputs position information of the vehicle 3 to the self-driving control device EC1.

The in-vehicle camera as an example of the sensor is a camera having an imaging element such as a charge coupled device (CCD) or a complementary metal oxide semiconductor (CMOS). The camera is installed, for example, at the center of a vehicle body front portion of the vehicle 3 and images a front center range as a detection range. Specifically, the camera detects the obstacle (see above) or a traffic signal present in the front of the own vehicle. The camera may execute image processing using data of the captured image, can detect information (for example, information of a speed or position of the obstacle based on the own vehicle) indicating a relationship between the obstacle detected by the image processing and the own vehicle, and can detect a position and a size of the traffic signal and color of signal light.

An around view camera as an example of the sensor includes a plurality of (for example, a sum of six of two in the front of the vehicle body, two in the rear of the vehicle body, and two on the side of the vehicle body) cameras installed in the front of the vehicle body 3, in the rear of the vehicle body, and on the side of the vehicle body respectively. The around view camera detects another vehicle or the like in a lane adjacent to a white line in the vicinity of the vehicle 3.

The radar as an example of the sensor includes a plurality of (for example, two) radars installed in the front of the vehicle body and in the rear of the vehicle body of the vehicle 3 respectively. The radar S3 may be installed only in the front of the vehicle body of the vehicle 3. The radar includes, for example, a millimeter wave radar, a sonar radar, and light detection and ranging or laser imaging detection and ranging (LiDAR). The radar scans and irradiates an electromagnetic wave such as an ultrasonic wave or a millimeter wave in a limited angle range and detects a time difference between a start time point of irradiation and a light receipt time point of reflected light, thereby detecting a distance between the own vehicle and the obstacle and a direction of the obstacle viewed from the own vehicle.

The laser range finder as an example of the sensor is installed on a vehicle body front right side, a vehicle body front left side, a vehicle body lateral right side, a vehicle body lateral left side, a vehicle body rear right side, and a vehicle body rear left side of the vehicle body 3, respectively. The laser range finder detects the obstacles (see above) or the like present on the front right side, the front left side, the lateral right side, the lateral left side, the rear right side, and the rear left side of the vehicle 3, respectively. Specifically, the radar range finder scans and irradiates laser light in a constant wide angle range and detects a time difference between a start time point of irradiation and a light receipt time point of reflected light, thereby detecting a distance between the own vehicle and the obstacle and a direction of the obstacle viewed from the own vehicle.

The sensor constituting the sensors S1 to Sm is not limited to the above-described in-vehicle camera, around view camera, radar, and laser range finder, and examples thereof may include a gyro sensor, an acceleration sensor, a geomagnetic sensor, a tilt sensor, an air temperature sensor, a barometric pressure sensor, a humidity sensor, and an illuminance sensor.

The memory M1 includes, for example, a random access memory (RAM) and a read only memory (ROM), and temporarily keeps a program or data necessary for executing the operation of the self-driving control device EC1 and data or information generated during the operation. The RAM is, for example, a work memory used during operation of the self-driving control device EC1. The ROM previously stores and keeps, for example, a program and data for controlling the self-driving control device EC1.

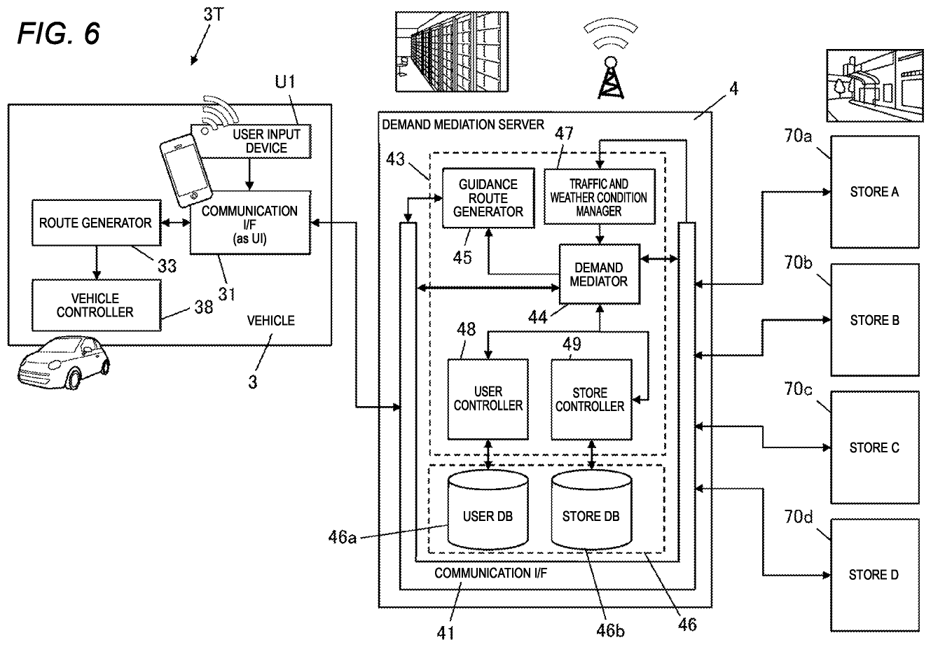

The communication interface 31 includes a communication circuit capable of communicating data or information with an external device (that is, the DM providing server 1, the edge server 2, the demand mediation server 4, and the weather information providing server 5) viewed from the vehicle 3 connected via the network NW. The communication interface 31 outputs data or information transmitted from the above-described external device to the self-driving control device EC1, or transmits data or information input from the self-driving control device EC1 to the external device (see above). In FIG. 1 and FIG. 6, for simplification of the drawing, a communication interface is abbreviated as “communication I/F” conveniently.

When input operation of a demand on an order of the user is performed via the user input device U1, a receiver 311 receives information of a guidance route transmitted from the demand mediation server 4 to a place such as facilities (for example, a store A to be described later) that satisfy the demand via the communication interface 31.

By a guidance route merger 36 of the route generator 33 to be described later, when information of the guidance route transmitted from the demand mediation server 4 is added (merged) to information of the route to a destination, a state manager 312 sets a guidance mode indicating a state in which the vehicle 3 is guided to facilities (for example, the store A to be described later) as a mode indicating a state of the vehicle 3.

The environment recognizer 32 recognizes a surrounding environment including a current position of the vehicle 3 (that is, the own vehicle) based on the detection output (see above) of each of the plurality of sensors S1 to Sm included in the vehicle 3. The environment recognizer 32 outputs the surrounding environment information including the current position information of the vehicle 3 to the route generator 33.

Based on the output of the environment recognizer 32, the route generator 33 calculates and generates a route on which the vehicle 3 travels (that is, a toll road such as a general road or a highway, or a combination thereof) in the self-driving to the destination of the vehicle 3 set by the user input device U1. The route generator 33 includes a general route generator 34, a local route generator 35, a guidance route merger 36, and a route evaluator 37 as functional configuration.

The general route generator 34 generates a general route (in other words, a traveling route) from the current position of the vehicle 3 to a desired destination of the user. Since a generation method of the general route from the current position to the destination of the vehicle 3 is a publicly known technique, detailed description of the generation method of the general route is omitted.

The local route generator 35 uses, for example, the data of the dynamic map provided from the DM providing server 1 and the weather information provided from the weather information providing server 5, and calculates a route (that is, a local route) for avoiding a collision with an obstacle (see above) during traveling of the local route between a node corresponding to the current position of the vehicle 3 and the next node among a plurality of nodes constituting the general route generated by the general route generator 34. Thus, the self-driving control device EC1 can more appropriately and seamlessly execute the self-driving of the vehicle 3 by bypassing a position such as traffic regulations generated on the local route in consideration of a real-time traffic condition or weather information.

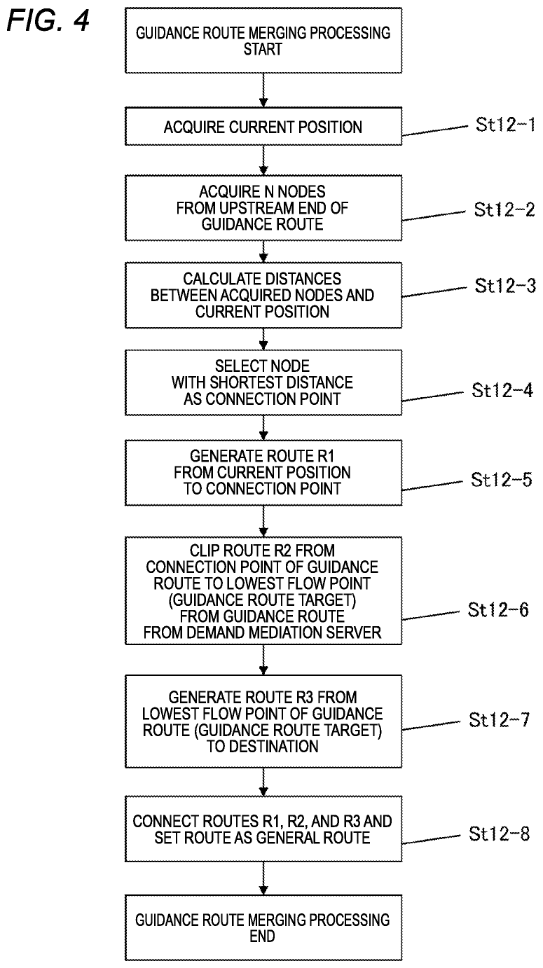

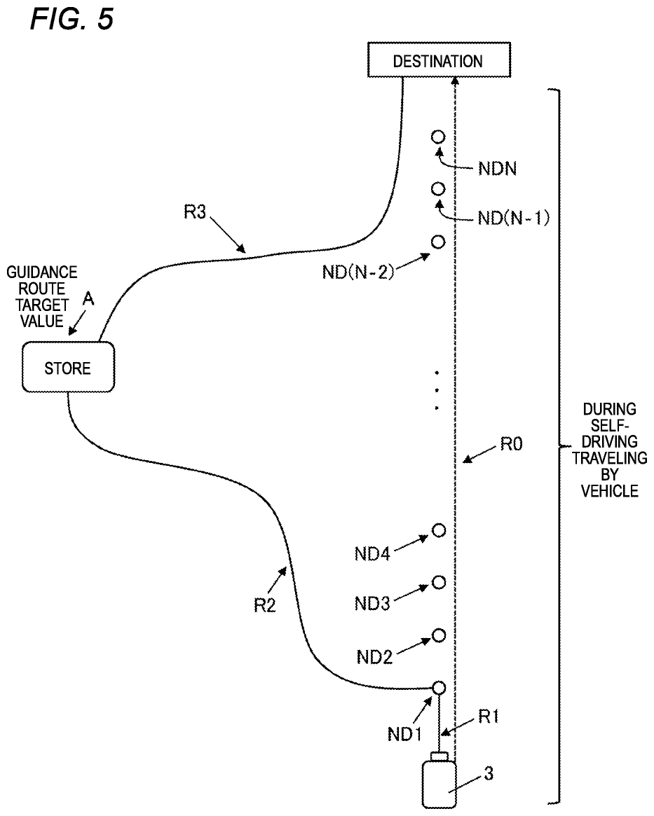

The guidance route merger 36 merges (adds) a route (that is, a guidance route) to a store (an example of facilities) by which the vehicle 3 drops from the current position of the vehicle 3 to a route (that is, a route to the destination) generated by the general route generator 34 based on approval operation (see below) of the user during the self-driving to the destination of the vehicle 3. As a result, the self-driving control device EC1 can interruptively add a route for dropping by the store (for example, the drive-through) on the way of the vehicle 3 to the destination by simple operation for approving the store corresponding to a request (demand) of the user, and thus can effectively utilize time in the vehicle 3 of the user during the self-driving. Details of the operation of the guidance route merger 36 will be described later with reference to FIG. 4 and FIG. 5.

The route evaluator 37 objectively evaluates suitability of the route generated by the general route generator 34 or the route after being merged by the guidance route merger 36 according to a predetermined algorithm. The route evaluator 37 evaluates on the generated route whether self-driving to desired arrival time set by the user is possible based on, for example, traffic regulations on the route, presence or absence of the obstacle, and a prediction result of arrival time, and calculates a score as an evaluation result. When the calculated score value is less than a predetermined threshold value, the route evaluator 37 instructs the general route generator 34 to regenerate the general route (that is, instructs regeneration of the general route). Note that the predetermined threshold value may be defined in the algorithm of the route evaluator 37 or may be stored as data in the memory M1 and read out from the memory M1 and referred to at the time of evaluation.

The vehicle controller 38 calculates, for example, a control value for controlling the control target equipment 39 required for self-driving such as an accelerator throttle opening degree of the vehicle 3, a braking force of the vehicle 3, a steering angle, and blinking timing of a winker. A control value is calculated such that the vehicle 3 travels in accordance with the route generated by, for example, a route generator 33 included in the self-driving support apparatus 10. The route is calculated and generated by the route generator 33 and input to the vehicle controller 38. The vehicle controller 38 transmits the calculated control value to an actuator (that is, a steering actuator, an accelerator pedal actuator, a brake actuator, and a winker blinking controller) for driving the respective control target equipment 39 (for example, steering, an accelerator pedal, a brake, and a direction indicator).

The control target equipment 39 is deployed in the vehicle 3, and control of actuation is received by the vehicle controller 38 during the self-driving of the vehicle 3. The control target equipment 39 is, for example, the steering actuator, the accelerator pedal actuator, the brake actuator, or the blinker flashing controller, but is not limited thereto.

The steering actuator is connected with steering disposed in the vehicle 3 and controls actuation (in other words, maintains or changes a traveling direction of the vehicle 3) of the steering during the self-driving in accordance with a control signal of the steering (not shown) input from the vehicle controller 38.

The accelerator pedal actuator is connected with the accelerator pedal disposed in the vehicle 3, and controls actuation of the accelerator pedal (in other words, maintains or increases and decreases a vehicle speed of the vehicle 3) during the self-driving in accordance with a control signal of the accelerator pedal (not shown) input from the vehicle controller 38.

The brake actuator is connected with a brake mechanism (hereinafter abbreviated as “brake”) disposed in the vehicle 3, and controls actuation of the brake (in other words, maintains or changes operation with respect to traveling of the vehicle 3) of the brake during the self-driving in accordance with a control signal of the brake (not shown) input from the vehicle controller 38.

The winker blinking controller is connected with a winker blinking mechanism (hereinafter abbreviated as a “brake”) disposed in the vehicle 3, and controls actuation of the winker (in other words, blinking of the winker for informing that the vehicle 3 turns left or turns right) during the self-driving in accordance with a control signal of the winker (not shown) input from the vehicle controller 38.

The demand mediation server 4 as an example of a server device includes a communication interface 41, a memory 42, a processor 43, and a storage 46. The communication interface 41, the memory 42, the processor 43, and the storage 46 are connected to each other via an internal bus to be able to input and output data or information.

The communication interface 41 includes a communication circuit capable of communicating data or information with an external device (that is, the DM providing server 1, the edge server 2, the vehicle 3, and the weather information providing server 5) viewed from the demand mediation server 4 connected via the network NW. The communication interface 41 outputs data or information transmitted from the above-described external device to the memory 42 or the processor 43, or transmits data or information input from the processor 43 to the external device (see above). In FIG. 1 and FIG. 6, for simplification of the drawing, a communication interface is abbreviated as “communication VF” conveniently.

The memory 42 includes, for example, a RAM and a ROM, and temporarily keeps a program or data that is necessary for executing the operation of the demand mediation server 4 and information or data that is generated during the operation. The RAM is, for example, a work memory used during the operation of the demand mediation server 4. The ROM previously stores and keeps, for example, a program and data for controlling the demand mediation server 4.

The processor 43 includes, for example, a central processing unit (CPU), a micro processing unit (MPU), a digital signal processor (DSP), or a field-programmable gate array (FPGA). The processor 43 functions as a controller of the demand mediation server 4 and performs control processing for overall control of operation of each unit of the demand mediation server 4, input/output processing of data between the units of the demand mediation server 4, data operation (calculation) processing, and data storage processing. The processor 43 operates in accordance with the program and data stored in the memory 42. Based on demand information transmitted from the vehicle 3, the processor 43 searches at least one facility (for example, a store) satisfying the demand of the user by using various databases (see FIG. 6) stored in the storage 46. The demand information includes, for example, information of a demand (request) on the order of a menu of the user in a store, destination information of the vehicle 3, and position information of the vehicle 3. The processor 43 generates a route to at least one store extracted as a result of the search (that is, a guidance route), and outputs demand response information (described later) including information on the store to the communication interface 41.

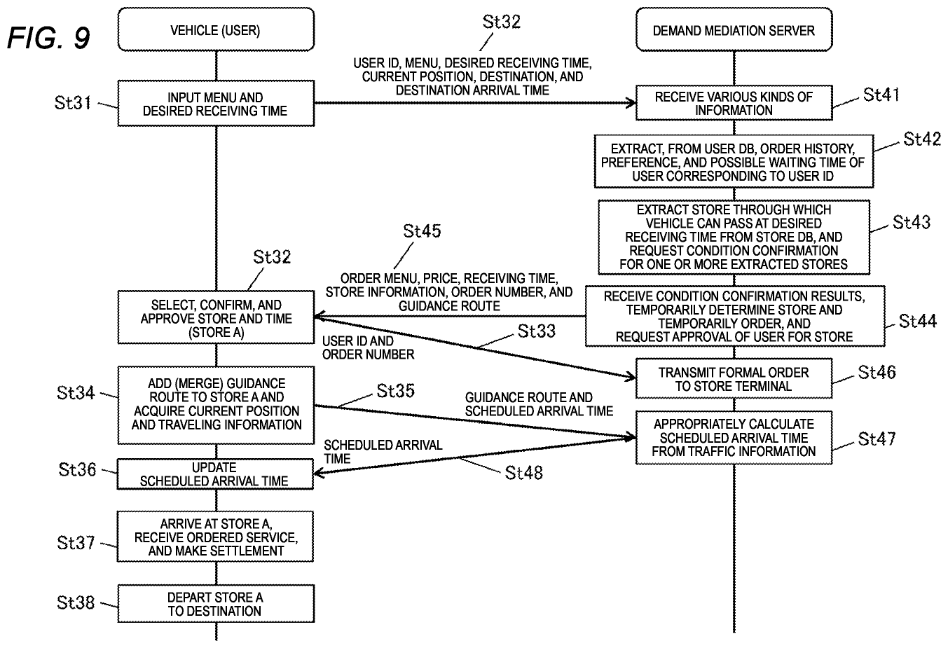

The processor 43 includes a demand mediator 44 and a guidance route generator 45 as a functional configuration. A detailed functional configuration of the processor 43 will be described later with reference to FIG. 6. Details of operation of the processor 43 will be described later with reference to FIG. 9.

The demand mediator 44 performs various kinds of mediation processing between a plurality of store side terminals (not shown in FIG. 1, see FIG. 6) connected to the demand mediation server 4 and the vehicle 3 based on the demand information corresponding to the demand (for example, search of a store where the user wants to drop by on the way to the destination) input by the user riding on the vehicle 3.

For example, the demand mediator 44 performs processing such as searching for a store satisfying a demand from a user, extracting searched store information, and ordering an order to the store side terminal as various kinds of mediation processing. When the demand information includes, for example, a demand of the user that “wants to go to a store at a position within a moving distance within 30 minutes from the destination”, the demand mediator 44 searches for a store at a position where one can arrive at a destination within 30 minutes, performs mediation such as inquiring with the store side terminal whether an ordered dish can be delivered at scheduled time when the vehicle 3 arrives at the store on the store.

The guidance route generator 45 generates a guidance route for guiding the vehicle 3 to a location (that is, the position of the store) included in the store information of at least one store extracted by the search of the store based on the demand information corresponding to the demand (for example, search of a store where the user wants to drop by on the way to the destination) input by the user riding on the vehicle 3. Thus, when a guidance route to the extracted store is generated, the guidance route generator 45 can generate the guidance route in consideration of the real-time road condition or weather condition by using the data of the dynamic map provided from the DM providing server 1 and the weather information provided from the weather information providing server 5.

The storage 46 includes an external storage medium such as a semiconductor memory (for example, a flash memory) built in the demand mediation server 4, the HDD, a solid state drive (SSD), or a memory card (for example, an SD card) not built in the demand mediation server 4. The storage 46 keeps data or information generated by the processor 43 and data or information (see FIG. 6) used by the processor 43. When the storage 46 includes a memory card, the memory card is removably installed on a housing of the demand mediation server 4.

The weather information providing server 5 constantly collects and updates weather information such as weather, temperature, and humidity, and transmits the above-described weather information to the vehicle 3 or the demand mediation server 4 in each case in response to a periodic request from the vehicle 3 or the demand mediation server 4.

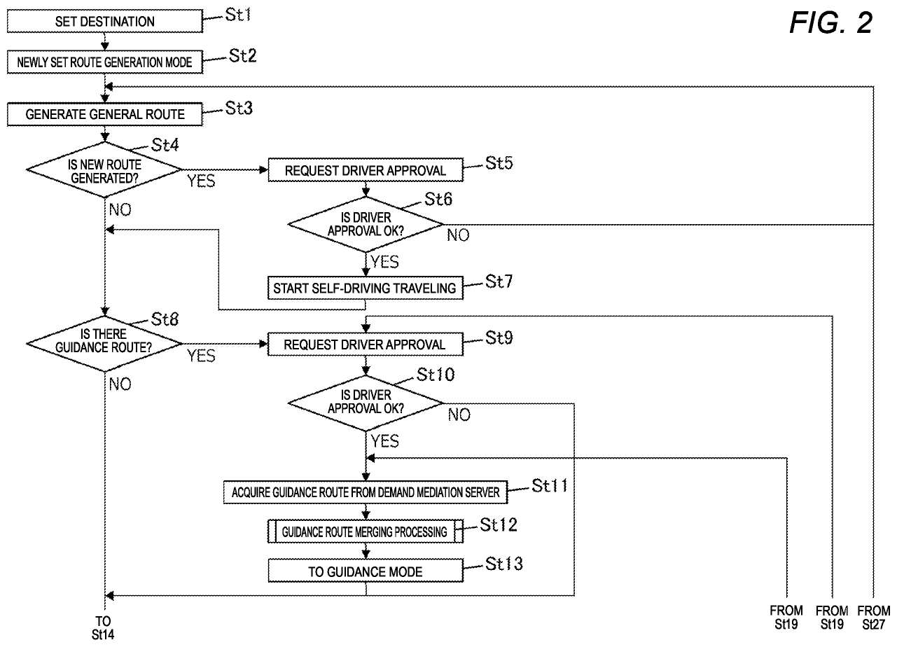

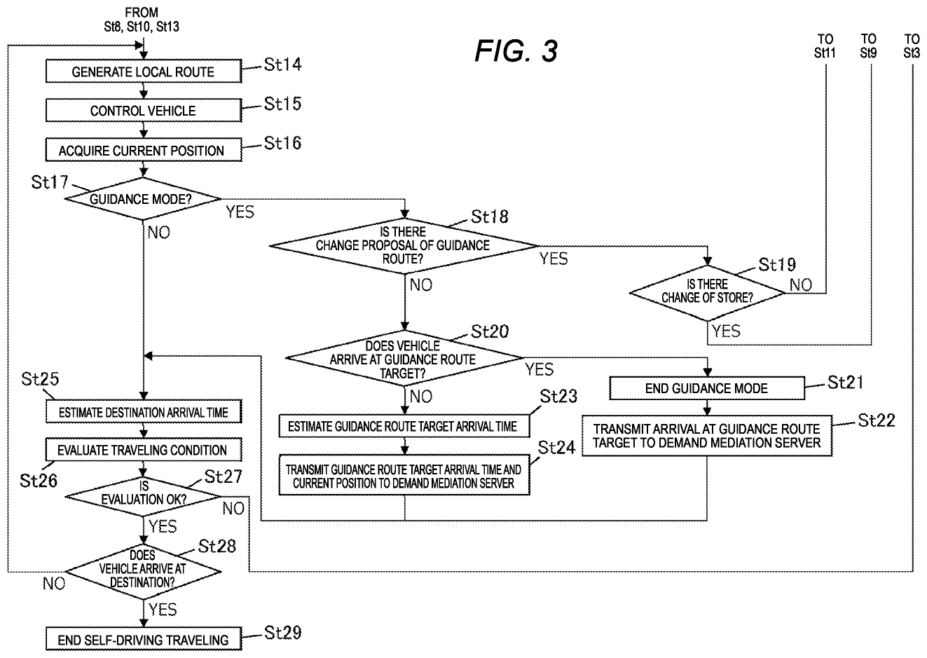

Next, an operation procedure of the self-driving of the vehicle 3 according to the first embodiment will be described with reference to FIG. 2 and FIG. 3. FIG. 2 and FIG. 3 are flowcharts showing an example of a control procedure of self-driving of the vehicle 3 in the self-driving control device according to the first embodiment. In the description of FIG. 2 and FIG. 3, the self-driving control device EC1 usually acquires information of a current position of the vehicle 3 calculated by a GPS receiver as an example of a sensor.

In FIG. 2, a destination to be a place to go of the vehicle 3 is set by the user input device U1 by operation of the user with respect to a destination setting screen (not shown) displayed on, for example, the HMI (not shown, for example, a display of a car navigation device) mounted in the vehicle 3 (St1). An example of the HMI includes a display of the car navigation device, but the present invention is not limited thereto.

The self-driving control device EC1 newly sets a route generation mode for generating a route to the destination set by step St1 (St2). Specifically, the general route generator 34 of the route generator 33 generates a route from the current position of the vehicle 3 to the destination (that is, the general route) (St3). The self-driving control device EC1 determines whether the route generated in step St3 is a newly generated route (St4). When it is determined that the route is not a newly generated route (St4, NO), processing of the self-driving control device EC1 proceeds to step St8.

On the other hand, when the self-driving control device EC1 determines that the route is a newly generated route (St4, yes), a screen for prompting approval of the user (for example, a driver) is displayed on the HMI (for example, a display of the car navigation device) (St5). When the self-driving control device EC1 receives approval operation of the user with respect to the screen displayed in step St5 via the user input device U1 (St6, YES), the vehicle 3 starts traveling by the self-driving (St7). After step St7, processing of the self-driving control device EC1 proceeds to step St8. On the other hand, when the approval operation of the user is not performed (St6, NO), processing of the self-driving control device EC1 returns to step St3 in order to cause the general route generator 34 to generate the general route again.

The self-driving control device EC1 determines whether a guidance route has been proposed from the demand mediation server 4 (in other words, whether information of the arrivable store according to the guidance route proposed by the demand mediation server 4 has been received in the communication interface 31) (St8). As described above, after start of self-driving in step St7, the self-driving control device EC1 transmits the demand information (see above) to the demand mediation server 4 based on operation of the user who wants to drop by the store on the way to go to the destination. The demand mediation server 4 transmits demand response information (to be described later) including information on at least one store satisfying the demand of the user to the vehicle 3 based on the demand information. When the proposal of the guidance route is not received from the demand mediation server 4 (St8, NO), the vehicle 3 continues self-driving in accordance with the route to the destination, so that processing of the self-driving control device EC1 proceeds to step St14.

On the other hand, when it is determined that the proposal of the guidance route has been received from the demand mediation server 4 (St8, YES), the self-driving control device EC1 displays a screen for prompting the user (for example, a driver) to approve going to the arrivable store in accordance with the proposed guidance route on the HMI (for example, a display of the car navigation device) (St9). When the self-driving control device EC1 approval receives operation of the user with respect to the screen displayed in step St9 via the user input device U1 (St10, YES), the user transmits information of an intention the user has approved to the demand mediation server 4 via the communication interface 31. Based on the information of the intention that the user has approved, the self-driving control device EC1 acquires information of the guidance route transmitted from the demand mediation server 4 via the communication interface 31 (St11).

The self-driving control device EC1 merges the guidance route to the route to the destination using the information of the guidance route acquired in step St11 (St12). As a result, the self-driving control device EC1 can appropriately add the guidance route to the store where the user wants to drop by on the way to the route to the destination. In addition, since the self-driving control device EC1 can arrange orders to the store satisfying the demand of the user during the self-driving to the destination, it is possible to effectively utilize time in the vehicle 3 of the user during self-driving and to improve convenience of the user. The merging process of the guidance route will be described later with reference to FIG. 4 and FIG. 5.

The self-driving control device EC1 as an example of the state manager sets a mode (hereinafter, referred to as a “guidance mode”) indicating that the user has approved going to the store proposed by the demand mediation server 4 in accordance with the guidance route in the memory M1 (St13). As a result, the self-driving control device EC1 can accurately perform state management whether the vehicle 3 is guided to the store satisfying the demand of the user at the current time. On the other hand, when approval operation of the user is not performed (St10, NO), since the vehicle 3 does not drop by the store proposed by the demand mediation server 4, processing of the self-driving control device EC1 proceeds to step St14.

In FIG. 3, the local route generator 35 of the route generator 33 generates a route (that is, a local route) for avoiding a collision with an obstacle (see above) during traveling of the local route between a node corresponding to the current position of the vehicle 3 and the next node in the general route generated in step St3 (St14). The vehicle controller 38 controls the control target equipment 39 in order that the vehicle 3 travels in accordance with the local route generated in step St14 (St15). After step St15, the self-driving control device EC1 acquires information of the current position of the vehicle 3 (St16). As described above, the self-driving control device EC1 usually acquires information of the current position of the vehicle 3 calculated by the GPS receiver not only at the time point in step St16.

After step St16, the self-driving control device EC1 refers to the memory M1 and determines whether the current time is in the guidance mode (St17). When it is determined that the current time is not in the guidance mode (St17, NO), the vehicle 3 corresponds to a state of arrival at the store satisfying the user s demand, so that processing of the self-driving control device EC1 proceeds to step St25.

When it is determined that the current time is in the guidance mode (St17, YES), the self-driving control device EC1 determines whether a change proposal of the guidance route has been received from the demand mediation server 4 (in other words, for example, whether information of a store or another store that is arrivable in accordance with the guidance route changed and proposed by the demand mediation server 4 based on a road condition or weather condition is received at the communication interface 31) (St18). The processing of step St18 may be executed when the user requests a change to another guidance route during the guidance mode or when the demand mediation server 4 has spontaneously proposed a change to another guidance route based on the road condition or weather condition. As a result, the self-driving control device EC1 can perform self-driving toward the store while appropriately bypassing a position where the traffic regulations have occurred even when traffic regulations such as accidents have occurred suddenly on a road on the way toward the store which is a guidance route target place. Therefore, the self-driving control device EC1 can dynamically change the guidance route to the store based on monitoring of the real-time traffic condition and weather condition of the demand mediation server 4, so that the congestion waiting time due to traffic regulations can be reduced and the user can spend stress-free in-vehicle time.

When it is determined that the change proposal of the guidance route has been received from the demand mediation server 4 (St18, YES), the self-driving control device EC1 determines whether a change in the store the vehicle 3 faces is caused by the change proposal of the guidance route based on the information transmitted from the demand mediation server 4 with respect to the change proposal (St19). The information transmitted from the demand mediation server 4 with respect to the change proposal includes, for example, presence or absence of the change in the store and information on the new store when the change in the store occurs. As a result, the self-driving control device EC1 is once confirmed as, for example, a guidance route target place (refer to a store A to be described later), but when there arises a situation in which it is difficult to use a store quickly at the time of arrival of the user due to circumstances on the store A side, the store in which the user drops by can be dynamically changed by intersystem cooperation with the real-time store of the demand mediation server 4, so that the convenience of the user can be further improved.

When it is determined that the change in the store does not occur (St19, NO), the information of the changed guidance route may be merged without requiring the approval operation of the user, and thus the processing of the self-driving control device EC1 returns to step SU 1. On the other hand, when it is determined that the change in the store occurs (St19, YES), the processing of the self-driving control device EC1 returns to step St9 since the approval operation of the user is required for facing the changed store.

On the other hand, when it is determined that the change proposal of the guidance route is not received from the demand mediation server 4 (St18, NO), the self-driving control device EC1 determines whether the vehicle 3 has arrived at the guidance route target place (that is, the drop-by store) based on the information of the current position of the vehicle 3 (St20). When it is determined that the self-driving control device EC1 as an example of the state manager has arrived at the guidance route target place (that is, the drop-by store) (St20, YES), setting of the guidance mode set in the memory M1 ends in step St13 (St21). As a result, the self-driving control device EC1 can accurately perform a state of finishing guiding the vehicle 3 to the store satisfying the demand of the user. The self-driving control device EC1 transmits information indicating an intention that the vehicle 3 has arrived at the guidance route target place (that is, the drop-by store) to the demand mediation server 4 via the communication interface 31 (St22).

On the other hand, when it is determined that the vehicle 3 has not arrived at the guidance route target place (that is, the drop-by store) (St20, NO), the self-driving control device EC1 estimates time (arrival time) when the vehicle 3 arrives at the guidance route target place (that is, the drop-by store) from the current position of the vehicle 3 (St23). The self-driving control device EC1 transmits information of the arrival time of the guidance route target place (that is, the drop-by store) estimated in step St23 and information of the current position of the vehicle 3 to the demand mediation server 4 (St24).

The self-driving control device EC1 estimates time (arrival time) when the vehicle 3 arrives at the destination set in step St1 from the current position of the vehicle 3 (St25). The route evaluator 37 of the route generator 33 evaluates a traveling condition of the route used by the vehicle 3 and calculates the evaluation result as a score (St26). The route evaluator 37 determines whether the evaluation is OK (in other words, whether the score calculated in step St26 is equal to or greater than a predetermined threshold value) (St27). When it is determined that the calculated score is less than the predetermined threshold value (St27, NO), the route generator 33 needs to regenerate the route of the self-driving of the vehicle 3, and thus the processing of the self-driving control device EC1 returns to step St3.

On the other hand, when the route evaluator 37 determines that the calculated score is equal to or greater than the predetermined threshold value (St27, YES), the self-driving control device EC1 determines whether the vehicle 3 has arrived at the destination set in step St1 based on the information of the current position of the vehicle 3 (St28). When it is determined that the vehicle 3 has arrived at the destination (St28, YES), the self-driving of the vehicle 3 ends, and thus the processing of the self-driving control device EC1 ends (St29). On the other hand, when it is determined that the vehicle has not arrived at the destination (St28, NO), the processing of the self-driving control device EC1 returns to step St14.

Here, the operation procedure of the guidance route merging process performed during the self-driving of the vehicle 3 described in step St12 will be described with reference to FIG. 4 and FIG. 5. FIG. 4 is a flowchart showing an example of an operation procedure of guidance route merging processing in the vehicle 3 according to the first embodiment. FIG. 5 is an explanatory diagram showing a transition example of a general route during self-driving of the vehicle 3 according to the first embodiment. The operation shown in FIG. 4 is mainly executed by the guidance route merger 36. In FIG. 5, a route R0 is a route (that is, the general route) from the current position of the vehicle 3 to the destination generated as the processing result of step St3.

In FIG. 4, the guidance route merger 36 acquires information of the current position of the vehicle 3 usually acquired by the vehicle 3 (St12-1). The guidance route merger 36 takes the current position of the vehicle 3 acquired in step St12-1 as an upstream end of the guidance route and acquires N (N: an integer of 2 or more) nodes ND1, ND2, ND3, ND4, ND(N−2), ND(N1), and NDN of a plurality of (that is, (N+1) or more) nodes constituting a route from the upstream end of the guidance route to the destination (St12-2). The guidance route merger 36 respectively calculates distances between the N nodes acquired in step St12-2 and the current position of the vehicle 3 acquired in step St12-1 (St12-3).

The guidance route merger 36 selects a node (specifically, the node ND1) with a shortest distance among the distances calculated in step St12-3 as a connection point (in other words, a connection site between the general route (that is, the route R0) generated in step St3 and the guidance route, and a start position of the guidance route) (St12-4).

The guidance route merger 36 generates a route from the current position to the node ND1 which is the connection point as a route R1 (St12-5). Based on the information on the guidance route transmitted from the demand mediation server 4 (see step St11), the guidance route merger 36 clips and extracts a route R2 from the connection point of the guidance route selected in step St12-4 to a lowest flow point (that is, the store A which is the guidance route target place, see FIG. 5) from the guidance route (St12-6). In other words, the guidance route merger 36 corrects the connection point (start position) of the guidance route and generates a guidance route from the corrected start position to the store A.

In step St11, the guidance route merger 36 does not use the information of the guidance route transmitted from the demand mediation server 4 as it is. The reason is as follows. Specifically, the vehicle 3 is moving after the self-driving is started in step St7. That is, the vehicle 3 has passed a certain period of time from a time point when the information of the guidance route is received from the demand mediation server 4 at the time point of step St11 to a time point when the guidance route merger 36 performs the processing of step St12-6. During the certain period of time, the vehicle 3 is proceeding by self-driving. Therefore, the guidance route merger 36 has a slippage at the start position of the guidance route included in the guidance route information transmitted from the demand mediation server 4, and thus corrects the connection point corresponding to the start position of the guidance route of the actual vehicle 3 in the processing of steps St12-4 to St12-6 and then generates the guidance route (that is, the route R2 described above).

The guidance route merger 36 generates a route R3 from the lowest flow point (that is, the store A which is the guidance route target place, see FIG. 5) of the guidance route to the destination (St12-7). The guidance route merger 36 connects routes R1, R2, and R3 respectively generated in steps St12-5, St12-6, and St12-7, and sets the route obtained by the connection as a general route (that is, a route after merging the guidance routes) (St12-8). As a result, the guidance route merger 36 can reset a route by bringing (merging) the guide route (route R2) for guiding the vehicle 3 to the store (for example, the store A) satisfying the demand of the user in the route to the destination by simple operation (for example, the approval operation in step St9) of the user during the self-driving toward the destination of the vehicle 3.

As described above, the guidance route merger 36 selects the node (for example, the node ND1) with a shortest distance from the current position of the vehicle 3 among the distances calculated in step St12-3 as the connection point (that is, the start position of the guidance route) (St12-4). Considering practical mounting by further studies, it is considered that it is more preferable to select the connection point described above in consideration of each of elements of time required for approving the guidance route by the driver of the vehicle 3, a distance required from the current traveling speed to a speed at which a traveling course can be changed, and time required for narrowing down the route from the plurality of nodes to the guidance route target value (store A). It is known that evaluation and selection of several routes that can be present from the node selected as the connection point to the guidance route target value (store A) are also required.

Therefore, the route generator 33 of the vehicle 3 can select the connection point (see above) in consideration of the plurality of elements described above. Specifically, first, time T1 required for the approval act of the driver is defined as a sum of processing time required for presentation from the route generator 33 to a display device (not shown) or the like of a route to the driver, time required for recognition and approval operation of the route by the driver, and operation delay time of the self-driving control device EC1 accompanying each operation. The route generator 33 estimates and derives the time T1 described above.

Next, the route generator 33 derives a distance L required to decelerate from a current traveling speed V of each node to the speed at which the traveling course can be changed. The route generator 33 evaluates a route from the node to the guidance route target value (store A) for each of a plurality of candidates (nodes) which may become the connection point, and derives time T2 by qualitatively validating time for narrowing down the node and route (in other words, operation time of the self-driving control device EC1) from an expected number of candidates (nodes).

The route generator 33 of the vehicle 3 selects a plurality of candidates (nodes) from downstream nodes from the current position of the vehicle 3 to a distance of “(V×T1)+L+(V×T2)” or more by using parameters (T1, L, T2) and the traveling speed V described above. The route generator 33 derives a route from the selected plurality of nodes to the guidance route target value (store A). The route generator 33 excludes nodes where the route cannot be derived from the candidates. The route generator 33 selects a node to be a candidate (that is, the connection point described above) in consideration of ease of traveling such as a road width at a predetermined time or route from the current position of the vehicle 3. As a result, the vehicle 3 can adaptively select the start position of the guidance route suitable for a more realistic traveling environment even during the self-driving, and thus can travel by adaptively changing (including merging) the guidance route without stopping traveling by the self-driving.

FIG. 6 is a block diagram showing a configuration example of the demand mediation system 100 using the demand mediation server 4 according to the first embodiment as a center. The same reference signs are given to the same components as those of the demand mediation system 100 shown in FIG. 1 and description thereof is simplified or omitted, and different contents will be described. Although FIG. 1 and FIG. 6 are block diagrams showing a configuration example of the same demand mediation system 100 according to the first embodiment, FIG. 1 mainly illustrates the configuration of the demand mediation system 100 relating to the self-driving taking the vehicle 3 as the center, and FIG. 6 mainly illustrates the configuration of the demand mediation system 100 relating to mediation with the store taking the demand mediation server 4 as the center.

The vehicle 3 shown in FIG. 6 includes at least the user input device U1, the communication interface 31, the route generator 33, and the vehicle controller 38. The configuration of the vehicle 3 is schematically illustrated in FIG. 6, and is illustrated in detail in FIG. 1. Since description of the user input device U1, the communication interface 31, the route generator 33, and the vehicle controller 38 is as described with reference to FIG. 1, description will be omitted here. As shown in FIG. 6, when the user holds a smartphone 3T, the smartphone 3T may be used as an example of the user input device U1 and the communication interface 31 of the vehicle 3.

The demand mediation server 4 shown in FIG. 6 is connected to communicate with terminals (hereinafter referred to as “store side terminals”) arranged in a plurality of facilities (here, a store is exemplified). Communication between the demand mediation server 4 and the plurality of store side terminals 70a, 70b, 70c, and 70d may be wired communication or wireless communication. Although FIG. 6 illustrates a form in which the store side terminals 70a, 70b, 70c, and 70d respectively corresponding to four stores A, B, C, and D are connected to the demand mediation server 4, it is needless to say that the store side terminal connected to the demand mediation server 4 is not limited to the store side terminals 70a to 70d shown in FIG. 6.

The demand mediation server 4 shown in FIG. 6 includes at least the communication interface 41, the processor 43, and the storage 46. FIG. 6 shows a functional configuration realized by the processor 43 in detail, and specifically, processing of respective units of the demand mediator 44, the guidance route generator 45, a traffic weather condition manager 47, a user controller 48, and a store controller 49 can be realized by cooperation of the processor 43 and the memory 42 (see FIG. 1). Since description of the demand mediator 44 and the guidance route generator 45 is as described with reference to FIG. 1, description will be omitted here.

The traffic weather condition manager 47 performs management such as usually receiving dynamic map data provided from the DM providing server 1 (see FIG. 1) and weather information provided from the weather information providing server 5 (see FIG. 1) separately and storing them in the storage 46. The traffic weather condition manager 47 outputs the received dynamic map data and weather information to the guidance route generator 45. The dynamic map data and weather information are used by appropriately referring to, for example, generation of the guidance route proposed for a vehicle (including the vehicle 3) that performs self-driving.

The user controller 48 accesses a user database 46a and performs management (extraction, new registration, update, deletion, and the like) of information on a user registered as the user of the demand mediation system 100.

The store controller 49 accesses a store database 46b and manages (for example, extraction, new registration, update, deletion, and the like) information on respective stores corresponding to the plurality of store side terminals 70a to 70d connected to communicate with the demand mediation server 4.

The storage 46 specifically includes the user database 46a and the store database 46b. In FIG. 6, for simplification of the drawing, the user database and the store database are abbreviated as a “user DB” and a “store DB” for convenience.

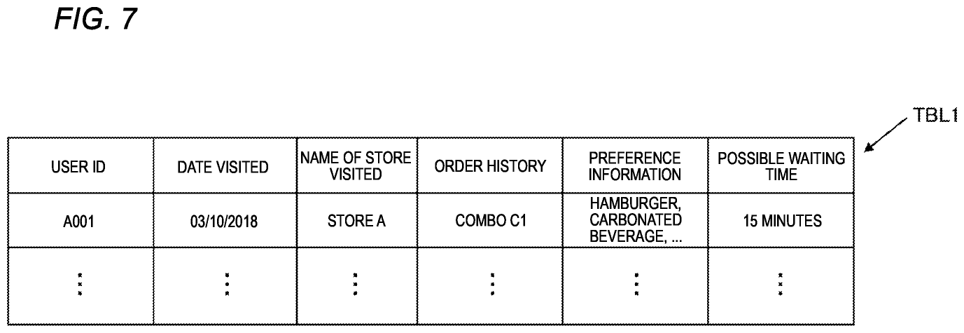

The user database 46a includes, for example, a relational database (RDB) and holds information on the user registered as a user of the demand mediation system 100 (see FIG. 7). FIG. 7 shows a configuration example of user data registered in the user database 46a.

As shown in FIG. 7, the user database 46a stores user data TBL1 configured by combining one record of user information for each user. The user information corresponds to visit date and time of the store, a visit store name, an order history, preference information (that is, information on food preference of the user), and information of possible waiting time to which the user does not feel stress for each user ID, which is identification information of the user. For example, according to the user information of the user ID “A001”, it can be determined that the user likes “hamburger, carbonated beverage, . . . ”, visited the store A and ordered “combo C1” on Mar. 10, 2018. Further, according to the user information of the user ID “A001”, it can be determined that waiting time (that is, possible waiting time) for receiving an ordered dish of a drive-through or the like by the user is “15 minutes”.

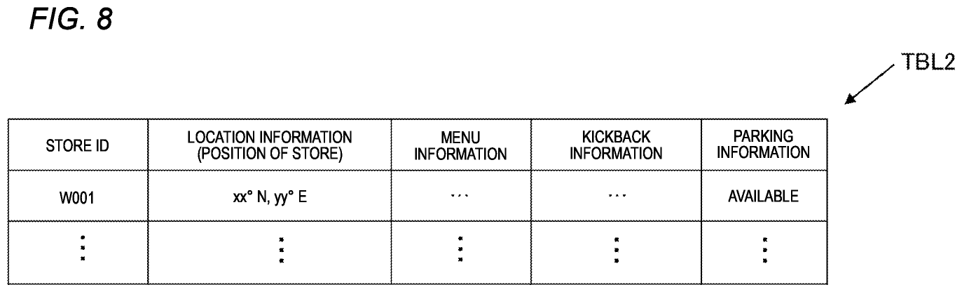

The store database 46b includes, for example, a RDB, and holds information on a plurality of stores registered as contacts used by the demand mediation system 100 (see FIG. 8). FIG. 8 shows a configuration example of store data registered in the store database 46b.

As shown in FIG. 8, the store database 46b stores store data TBL2 configured by combining one record of store information for each store. The store information corresponds to location information indicating the position of the store, menu information of a dish (food and drink) that can be provided to a customer such as the user in the store, information on a dish (food and drink) selected as a kickback object by the store, and parking lot information for each store ID which is identification information of the store. The parking lot information indicates a vacant condition of a parking lot that can be used by a customer in cooperation with a parking lot owned by the store, an owner, or the like. The vacant condition of the parking lot may be information indicating only whether there is a vacant space, or may be quantitative information specifically indicating that how many vacant spaces there are without being limited to the information. For example, according to the store information of the store ID “W001”, the store is located at “north latitude xx degree and east longitude yy degree” and can determine the menu information that can be provided in the store, the parking lot information indicating the vacant condition of the parking lot, and the information on a dish (food and drink) to be kicked back.

The store side terminal 70a includes, for example, a personal computer (PC) and is connected to communicate with the demand mediation server 4. When various kinds of management processing are performed in the store A, for example, an order request transmitted from the demand mediation server 4 is received, the store side terminal 70a instructs cooking instructions for an ordered dish (food and drink) included in the order request to various management apparatuses deployed in various areas (for example, in a hall and in a kitchen) in the store A. In addition, the store side terminal 70a always grasps data indicating an overcrowding condition of the store A within business hours, determines whether the ordered dish can be provided from the demand mediation server 4 at specified time, and responds the determination result to the demand mediation server 4.

The store side terminal 70b includes, for example, a PC and is connected to communicate with the demand mediation server 4. When various kinds of management processing are performed in a store B, for example, an order request transmitted from the demand mediation server 4 is received, the store side terminal 70b instructs cooking instructions for an ordered dish (food and drink) included in the order request to various management apparatuses deployed in various areas (for example, in a hall and in a kitchen) in the store B. In addition, the store side terminal 70b always grasps data indicating an overcrowding condition of the store A within business hours, determines whether the ordered dish can be provided from the demand mediation server 4 at specified time, and responds the determination result or a vacant condition of a parking lot including forecast at the specified time to the demand mediation server 4 as the parking lot information.

The store side terminal 70c includes, for example, a PC and is connected to communicate with the demand mediation server 4. When various kinds of management processing are performed in a store C, for example, an order request transmitted from the demand mediation server 4 is received, the store side terminal 70c instructs cooking instructions for an ordered dish (food and drink) included in the order request to various management apparatuses deployed in various areas (for example, in a hall and in a kitchen) in the store C. In addition, the store side terminal 70c always grasps data indicating an overcrowding condition of the store C within business hours, determines whether the ordered dish can be provided from the demand mediation server 4 at specified time, and responds the determination result to the demand mediation server 4.

The store side terminal 70d includes, for example, a PC and is connected to communicate with the demand mediation server 4. When various kinds of management processing are performed in a store D, for example, an order request transmitted from the demand mediation server 4 is received, the store side terminal 70d instructs cooking instructions for an ordered dish (food and drink) included in the order request to various management apparatuses deployed in various areas (for example, in a hall and in a kitchen) in the store D. In addition, the store side terminal 70d always grasps data indicating an overcrowding condition of the store D within business hours, determines whether the ordered dish can be provided from the demand mediation server 4 at specified time, and responds the determination result to the demand mediation server 4.

Next, an operation procedure related to various kinds of demand mediation such as search for a store satisfying a demand of a user and an order request to the store in the demand mediation system 100 according to the first embodiment will be described with reference to FIG. 9. FIG. 9 is a sequence diagram showing an example of an operation procedure of demand mediation in the demand mediation system according to the first embodiment. The sequence diagram shown in FIG. 9 shows a flowchart showing a time series of the operation procedure of the vehicle 3 and a flowchart showing a time series of the operation procedure of the demand mediation server 4. As a premise of the description of FIG. 9, the vehicle 3 is in a state in which self-driving is performed toward a destination set based on operation of the user.

In FIG. 9, the vehicle 3 receives input of an order menu desired by the user (for example, an ordered dish that is food and drink that can be provided in the drive-through) and desired receipt time of the order menu in order to effectively use time in the vehicle 3 for a meal, for example, until the vehicle 3 arrives at the destination by operation of the user with respect to the user input device U1 during self-driving (St31). The vehicle 3 transmits the demand information including the user ID which is the identification information of the user, the order menu and the desired receipt time input in step St31, the current position and destination of the vehicle 3, and the destination arrival time calculated at the time of setting the destination to the demand mediation server 4 (St32).

In step St32, the demand mediation server 4 receives various kinds of information transmitted from the vehicle 3 (St41). The demand mediation server 4 refers to the user database 46a (see FIG. 7), and extracts, from the user database 46a, information of the past order history, preference, and possible waiting time of the user corresponding to the user ID received in step St41 (St42).

The demand mediation server 4 extracts information on at least one store through which the vehicle 3 can pass (that is, arrival) at the desired receipt time received in step St41 with reference to the store database 46b (see FIG. 8) (St43). The demand mediation server 4 transmits a confirmation request of an overcrowding condition at a predetermined time before and after (for example, 5 minutes before and after) the desired receipt time for the at least one extracted store (for example, the store A) to the store side terminal (for example, the store side terminal 70a) corresponding to each store (St43).

The demand mediation server 4 respectively receives confirmation results (that is, a prediction result of the overcrowding condition 5 minutes before and after the desired receipt time) from store side terminals with respect to a confirmation request for the overcrowding condition in step St43 (St44). The demand mediation server 4 temporarily determines as the store (order store) satisfying the demand (that is, the order menu) of the user preferentially in an order of the store where the dish of the order menu can be quickly provided to the user without overcrowding in a period of time of the desired receipt time based on the confirmation result from each of the store side terminals. The demand mediation server 4 temporarily orders the order menu of the user in the store (St44), and generates a guidance route for guiding the vehicle 3 to the store based on information of the current position of the vehicle 3 transmitted in step St32 and information of the store position temporarily determined.

Further, the demand mediation server 4 generates a screen (not shown) that prompts an approval request of the user for the temporarily determined store and transmits demand response information (in other words, an approval request to the user) including the screen data to the vehicle 3 (St44). Specifically, the demand mediation server 4 transmits, to the vehicle 3, various kinds of information including the order menu, payment amount for the order menu, receipt time, the temporarily determined store information, a temporary order number, and the guidance route and the screen data that prompts the approval request of the user as the demand response information (St45).

In step St45, the vehicle 3 receives the demand response information transmitted from the demand mediation server 4 and displays the screen data that prompts the approval request of the user on the HMI (not shown) mounted in the vehicle 3. The vehicle 3 selects and approves a store satisfying the own demand (in other words, a receiving store of a dish of the order menu) and time at which the dish is received by operation of the user with respect to the user input device U1 (St32). In the following description, the store selected by the approval operation of the user is set as the store A.

In step St32, the vehicle 3 may transfer the screen data that prompts the approval request of the user to the smartphone 3T held by the user via the communication interface 31 and a mobile phone network (not shown) instead of displaying the screen data on the HMI (not shown) mounted in the vehicle 3. As a result, the vehicle 3 can display a screen that prompts the approval request of the user on a display of the smartphone 3T. In this case, the store (for example, the store A) satisfying the demand of the user is selected and approved by operation of the user with respect to the smartphone 3T, and information on the selected and approved store (for example, the store A) is transferred from the smartphone 3T to the vehicle 3.

When the store (for example, the store A) satisfying the demand of the user is selected and approved, the vehicle 3 transmits information on the selected and approved store (for example, the store A) and the user ID and the order number included in the demand response information to the demand mediation server 4 (St33).

Based on the transmission of various kinds of information transmitted from the vehicle 3 in step St33, the demand mediation server 4 uses the user ID and the order number to perform request processing of the order (that is, transmission of order data) on the store side terminal (for example, the store side terminal 70a of the store A) of the store selected and approved by the user (St46).

The vehicle 3 uses the information of the guidance route transmitted from the demand mediation server 4 in step St45 to perform processing (see FIG. 4) of adding (merging) the guidance route to the store A selected and approved in step St32 to the route to the destination (St34). After merging the guidance route, the vehicle 3 acquires the current position information and the traveling information (St34), and calculates scheduled arrival time to the store A based on the current position information and the traveling information. The vehicle 3 transmits information of the guidance route merged by the guidance route merger 36 and information of the calculated scheduled arrival time to the store A to the demand mediation server 4 (St35).

The demand mediation server 4 appropriately calculates and updates the scheduled arrival time to the store A in consideration of traffic information, weather information, or the like in the guidance route based on the information of the guidance route and the scheduled arrival time transmitted from the vehicle 3 in step St35 (St47). The demand mediation server 4 transmits the information of the scheduled arrival time to the store A updated in step St47 to the vehicle 3 (St48).

The vehicle 3 uses the information of the scheduled arrival time to the store A transmitted from the demand mediation server 4 in step St48 to update the scheduled arrival time calculated in the own vehicle in step St34 (St36). As a result, the vehicle 3 can set the scheduled arrival time to the store A reflecting the information of the traffic condition or weather condition that can change in real time, can notify more accurate scheduled arrival time to the store A to the user, and can improve convenience of the user.

When the vehicle 3 arrives at the store A, the user receives the dish of the order menu from an assistant of the store A, and performs necessary settlement processing (St37). After step St37, the vehicle 3 departs the store A and starts moving toward the destination by self-driving (St38).

As described above, in the demand mediation system 100 according to the first embodiment, the self-driving control device EC1 is mounted on the vehicle 3 connected to communicate with the demand mediation server 4. The self-driving control device EC1 generates a route to the destination in the route generator 33, and controls traveling during self-driving of the vehicle 3 to the destination in the vehicle controller 38 based on the route information to the destination. In response to input operation of a demand on the order the user, the self-driving control device EC1 as an example of the receiver receives information of a guidance route to facilities (for example, the store A) satisfying the demand, which is transmitted from the demand mediation server 4. The self-driving control device EC1 generates information of a route obtained by merging the guidance route to the store A with the route to the destination as route information to the destination in response to the approval operation of the user with respect to the store A.

As a result, when the user wants to drop by the store such as a drive-through during self-driving toward the destination of the vehicle 3, in response to simple operation (for example, the approval operation) of the user, the self-driving control device EC1 or the vehicle 3 can adaptively change the route to the destination by including selection of the store of a drive-through or change of the store during traveling of the guidance route. Therefore, since the user can perform an order using the drive-through in advance until the vehicle 3 arrives at the store of the drive-through, it can be expected that the ordered dish is received when the vehicle 3 arrives at the store, and the self-driving control device EC1 or the vehicle 3 can effectively use the time during self-driving by the user to accurately improve convenience.

The self-driving control device EC1 recognizes a surrounding environment including the position of the vehicle 3 in the environment recognizer 32 based on detection output of each of the plurality of sensors S1 to Sk included in the vehicle 3, and generates the route to the destination in the route generator 33 based on the recognized surrounding environment information. Thus, the self-driving control device EC1 or the vehicle 3 can generate an appropriate route in consideration of surrounding environmental information of the vehicle 3, and thus can safely perform self-driving to the place to go of the vehicle 3.

Further, the self-driving control device EC1 as an example of the state manager sets a guidance mode indicating a state in which the vehicle 3 is guided to the store A when the guidance route (for example, the route to the store A selected by the approval operation of the user) is merged with the route to the destination. As a result, the self-driving control device EC1 or the vehicle 3 can accurately perform state management whether the vehicle 3 is guided to the store A satisfying the demand of the user at the current time.

When the vehicle 3 arrives at the store A, the self-driving control device EC1 as an example of the state manager sets end of the guidance mode. As a result, the self-driving control device EC1 or the vehicle 3 can accurately perform a state of finishing guiding the vehicle 3 to the store A satisfying the demand of the user.

When information of a new guidance route (an example of a second guidance route) where the guidance route to the store A is changed, which is transmitted from the demand mediation server 4 in the guidance mode, is received, the self-driving control apparatus EC1 generates information of a route obtained by merging the new guidance route with the route to the destination as route information to the destination. As a result, the self-driving control device EC1 or the vehicle 3 can perform self-driving toward the store A while appropriately bypassing a position where the traffic regulations have occurred even when traffic regulations such as accidents have occurred suddenly on a road on the way toward the store A. Therefore, the self-driving control device EC1 or the vehicle 3 can dynamically change the guidance route to the store A based on monitoring of the real-time traffic condition and weather condition of the demand mediation server 4, so that the congestion waiting time due to traffic regulations can be reduced and the user can spend stress-free in-vehicle time.

When information of a new guidance route (an example of a third guidance route) to the store B different from the store A, which is transmitted from the demand mediation server 4 in the guidance mode, is received, the self-driving control apparatus EC1 generates information of a route obtained by merging the new guidance route with the route to the destination as route information to the destination in response to the approval operation of the user with respect to the store B. As a result, the self-driving control device EC1 or the vehicle 3 is once confirmed as, for example, the store A, but when there arises a situation in which it is difficult to use a store quickly at the time of arrival of the user due to circumstances on the store A side, the store in which the user drops by can be dynamically changed by intersystem cooperation with the real-time store of the demand mediation server 4, so that the convenience of the user can be further improved.

In addition, in the demand mediation system 100 according to the first embodiment, the vehicle 3 including the self-driving control device EC1 that controls self-driving and the demand mediation server 4 are connected to communicate with each other. The vehicle 3 transmits the demand information including information of the destination and position information of the vehicle to the demand mediation server 4 in response to input operation of the demand on the order of the user s during self-driving to the destination. The demand mediation server 4 searches at least one facility (for example, store A) satisfying the demand of the user based on the demand information transmitted from the vehicle 3, and transmits the information of the guidance route from the position of the vehicle 3 to the store A and the information on the store A to the vehicle 3. The vehicle 3 acquires the information of the guidance route transmitted from the demand mediation server 4 and the information on the store A, and generates information of a route obtained by merging the guidance route with the route to the destination as route information to the destination in response to the approval operation of the user with respect to the store A.

As a result, when the user wants to drop by the store such as a drive-through during self-driving toward the destination of the vehicle 3, the demand mediation system 100 can adaptively change the route to the destination by including the store of the drive-through in response to simple operation (for example, the approval operation) of the user. Therefore, since the user can perform an order using the drive-through in advance until the vehicle 3 arrives at the store of the drive-through, it can be expected that the ordered dish is received when the vehicle 3 arrives at the store, and the self-driving control device EC1 or the vehicle 3 can effectively use the time during self-driving by the user to accurately improve convenience.

Although various embodiments have been described above with reference to the drawings, it is needless to say that the present disclosure is not limited to such examples. It will be apparent to those skilled in the art that various alterations, modifications, substitutions, additions, deletions, and equivalents can be conceived within the scope of the claims, and it should be understood that they also belong to the technical scope of the present disclosure. Each component in various embodiments described above may be combined arbitrarily in the range without deviating from the spirit of the invention.

In the embodiment described above, the self-driving control device EC1 or the vehicle 3 may dynamically change and generate a guidance route depending on the traffic condition of the road on which the vehicle 3 travels, after for example, the guidance route generated by the demand mediation server 4 is merged with the route to the destination of the vehicle 3. That is, the self-driving control device EC1 or the vehicle 3 dynamically changes and generates the guidance route based on the detection information (in other words, the surrounding environmental information of the vehicle 3) of the sensors S1 to Sm in the guidance mode indicating a state of guiding the vehicle 3 to facilities (for example, the store A) after merging of the above-described guidance route. The self-driving control device EC1 or the vehicle 3 transmits (in other words, feeds back) information of the changed guidance route to the demand mediation server 4 via the network NW. Upon receiving the information on the changed guidance route transmitted from the vehicle 3, the demand mediation server 4 calculates the scheduled arrival time to the store A of the vehicle 3 and notifies the scheduled arrival time to the store side terminal 70a by using the changed guidance route for the store A where the dish of the user corresponding to the vehicle 3 is ordered.

As a result, the vehicle 3 can reduce delay of arrival to the store A as much as possible by changing (for example, changing to a bypass route) the guidance route to the store A depending on the surrounding environment information (for example, information of an intention indicating that lane construction is performed on a road where the vehicle 3 travels). In response to the feedback from the vehicle 3, the demand mediation server 4 can provide the latest information to the store A by notifying change of the scheduled arrival time and the changed scheduled arrival time of the vehicle 3 to the store A that is a recipient of an order of the dish, thereby improving the convenience.

The present application is based on Japanese Patent Application No. 2018-060028 filed on Mar. 27, 2018, the contents of which are incorporated herein by reference.

The present disclosure is useful as the self-driving control device, a vehicle, and a demand mediation system that adaptively change a route to a destination in response to simple operation of a user by including a store of a drive-through and make a user effectively use time during self-driving to improve convenience accurately when a user such as a driver wants to use the drive-through during self-driving.

1. A self-driving control device mountable on a vehicle configured to communicate with a server device, the self-driving control device comprising:
a processor; and
a memory comprising instructions that, when executed by the processor, cause the processor to perform operations comprising:
generating a route to a destination;
controlling traveling during self-driving of the vehicle to the destination based on information of the route to the destination; and
receiving information of a guidance route to a place satisfying the demand transmitted from the server device in response to input operation of a demand on an order of a user,
wherein in generating the route to the destination, the processor generates information of a route obtained by merging the guidance route with the route to the destination as the information of the route to the destination in response to approval operation of the user with respect to the place.

2. The self-driving control device according to claim 1,
wherein the operations further comprise:
recognizing a surrounding environment including a position of the vehicle based on detection output of each of a plurality of sensors of the vehicle,
wherein in generating the route to the destination, the processor generates the route to the destination based on information of the surrounding environment.

3. The self-driving control device according to claim 1,
wherein the operations further comprise:
managing a mode state to set a guidance mode in a case where the guidance route is merged with the route to the destination, the guidance mode indicating a state in which the vehicle is guided to the place.

4. The self-driving control device according to claim 3,
wherein in managing the mode state, the processor sets an end of the guidance mode in a case where the vehicle arrives at the place.

5. The self-driving control device according to claim 3,
wherein in generating the route to the destination, in a case of receiving information of a second guidance route transmitted from the server device during the guidance mode is received, the second guidance route being a route where the guidance route to the place is changed, the processor generates information of a route obtained by merging the second guidance route with the route to the destination as the information of the route to the destination.

6. The self-driving control device according to claim 5,
wherein the information of the second guidance route is transmitted from the server device in response to input operation of the user requesting the guidance route.

7. The self-driving control device according to claim 5,
wherein the information of the second guidance route is transmitted from the server device based on at least one of a road condition and a weather condition.

8. The self-driving control device according to claim 3,
wherein in generating the route to the destination, in a case of receiving information of a third guidance route to another place different from the place which is transmitted from the server device during the guidance mode, the processor generates information of a route obtained by merging the third guidance route with the route to the destination as the information of the route information to the destination in response to the approval operation of the user on the another place.

9. The self-driving control device according to claim 3,
wherein the operations further comprise:
recognizing a surrounding environment including a position of the vehicle based on detection output of each of a plurality of sensors of the vehicle,
wherein in generating the route to the destination, the processor is configured to:
change the route to the destination based on the information of the surrounding environment during the guidance mode; and
transmitting information of a changed route to the destination to the server device.

10. The self-driving control device according to claim 2,
wherein in generating the route to the destination, after the guidance route is merged with the route to the destination, the processor changes the guidance route based on the information of the surrounding environment during a guidance mode indicating a state of guiding the vehicle to the place.

11. The self-driving control device according to claim 2,
wherein the operations further comprise:
estimating an arrival time at the place; and
transmitting position information of the vehicle and the arrival time to the server device.

12. The self-driving control device according to claim 1,
wherein in generating the route to the destination, the processor corrects a start position of the guidance route obtained from the information of the guidance route transmitted from the server device based on position information of the vehicle.

13. The self-driving control device according to claim 12,
wherein the start position of the guidance route is a connection point of the route to the destination and the guidance route.

14. The self-driving control device according to claim 13,
wherein in generating the route to the destination, the processor is configured to:
obtain a plurality of nodes forming the route to the destination from the position of the vehicle to the destination;
select one of the plurality of nodes as the connection point.

15. The self-driving control device according to claim 14,
wherein in generating the route to the destination, the processor extracts a route from the connection point to the place from the information of the guidance route transmitted from the server device.

16. The self-driving control device according to claim 15,
wherein in generating the route to the destination, the processor generates, as the route to the destination, a route connecting a route from the position of the vehicle to the connection point, the route from the connection point to the place, and a route from the place to the destination.

17. The self-driving control device according to claim 14,
wherein the one of the plurality of nodes selected as the connection point is a closest node from the position of the vehicle.

18. The self-driving control device according to claim 14,
wherein in generating the route to the destination, the processor is configured to:
estimate a first time required for the approval operation of the user;
derive a distance required to decelerate to a speed enabling the vehicle to change a traveling course;
derive a second time required for evaluating a plurality of routes from the plurality of nodes to the place and narrowing down a route and node based on the number of plurality of nodes; and
select one of the plurality of nodes as the connection point based on the first time, the distance, the second time, the position of the vehicle, and a speed of the vehicle.

19. A vehicle configured to communicate with a server device and comprising a self-driving control device configured to control self-driving,
wherein the self-driving control device comprises:
a processor; and
a memory comprising instructions that, when executed by the processor, cause the processor to perform operations comprising:
generating a route to a destination;
controlling traveling during self-driving of the vehicle to the destination based on information of the route to the destination; and
receiving information of a guidance route to a place satisfying the demand transmitted from the server device in response to input operation of a demand on an order of a user,
wherein in generating the route to the destination, the processor generates information of a route obtained by merging the guidance route with the route to the destination as the information of the route to the destination in response to approval operation of the user with respect to the place.

20. A demand mediation system comprising:
a vehicle comprising a self-driving control device configured to control self-driving; and
a server device,
wherein the vehicle and the server are configured to communicate with each other,
wherein the vehicle comprises:
a first processor; and
a first memory comprising instructions that, when executed by the first processor, cause the first processor to perform first operations comprising:
transmitting demand information including information of a destination and position information of the vehicle to the server device in response to input operation of a demand on an order of the user during self-driving to the destination,
wherein the server device comprises:
a second processor; and
a second memory comprising instructions that, when executed by the second processor, cause the second processor to perform second operations comprising:
searching at least one place satisfying the demand; and
transmitting information of a guidance route from a position of the vehicle to the at least one place and information on the at least one place to the vehicle based on the demand information transmitted from the vehicle, and
wherein the first operation further comprises:
receiving information of the guidance route transmitted from the server device and information on the at least one place; and
generating information of a route obtained by merging the guidance route with a route to the destination as information of the route to the destination in response to approval operation of the user on the at least one place.
